(19) United States
(12) Patent Application Publication
(10) Pub. No.: US 2010/0082496 A1
(43) Pub. Date: Apr. 1, 2010

(54) REAL ESTATE SITE SELECTION SYSTEM AND METHOD

(75) Inventor: Robert D. HUTSON,, JR., Blue Ridge, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: SYMMEDIAN TECHNOLOGIES, INC., Atlanta, GA (US)

(21) Appl. No.: 12/423,878

(22) Filed: Apr. 15, 2009

Related U.S. Application Data
(60) Provisional application No. 61/101,435, filed on Sep. 30, 2008.

(51) Int. Cl. G06Q 10/00; G06F 3/00; G06F 7/04; G06Q 30/00; G06Q 50/00

(52) U.S. Cl. 705/80; 715/738; 726/4; 715/742; 705/26; 705/7

(57) ABSTRACT

A computerized site selection system and method. In one embodiment, the computerized site selection system includes a representation means for generating visual representations of data to at least one user, an interface means having interactive user controls for manipulating data in response to an action by the at least one user, an analysis means for analyzing data, a communication means for sending and receiving data to and from the at least one user, a storage means for storing data saved by the at least one user, and a network server in communication with and programmed for controlling the functions performed by each of the representation means, interface means, analysis means, communication means, and storage means, where the data contains real estate information, and where at least one of the representation means, interface means, analysis means, and communication means is operatively associated with the at least one user through a network connection.

### CROSS-REFERENCE TO RELATED PATENT APPLICATION

This application claims the benefit, pursuant to 35 U.S.C. §119(e), of U.S. provisional patent application Ser. No. 61/101,435, filed Se. 30, 2008, entitled “Real Estate Site Selection System and Method” by Robert D. Hutson, Jr., which is incorporated herein by reference in its entirety.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### FIELD OF THE INVENTION

The present invention is generally related to real estate site selection. More specifically, it relates to a computerized real estate site selection system and method of use.

### BACKGROUND OF THE INVENTION

Existing computer readable programs and systems, such as web-based applications or internal software, are capable of displaying stored data, such as from a database, often for the purpose of making presentations with visual representations of an underlying data model. The generated output may provide some visual cues that allow key decision makers to see sets of values for a given set of variable inputs. The presentations and their graphical aspects may be simply a visual summary of data.

When viewed as complete business applications, current programs have several important limitations. One such limitation is that changes made by a user may not be saved between sessions, meaning that a user who finds an optimum combination of factors must print out or perform screen captures to save this state. This is cumbersome because it may require that the data be re-entered in the event that the user wishes to revisit the model later, in order to make further adjustments. Another limitation is that the presentation files generated by the program may not be internet-accessible to parties with an interest in exploring different scenarios from the perspective of one or more specific categories of user. Further, existing programs cannot hide or show data based on the specific category of a user, since this is extraneous to the goals of some presentation software. Requirements such as the need to integrate with a persistence layer, services-oriented platforms, and provide context sensitive functionality based on user role are not easily addressed.

While advances in JavaScript and XML-aware web browsers have led to the rise of Web 2.0 applications, these are still limited by a number of factors, including the fact that they are a blend of different technologies, syntaxes and programming models. This hampers rapid application development because it requires a broader range of skill sets for developers than is ideal. In addition, each browser behaves differently, causing additional time and expense as developers and quality assurance testers work around unanticipated behaviors. There is a need for a more comprehensive software solution for businesses requiring integration with sophisticated back end systems via rich user interfaces.

In the context of real estate development, among other aspects, there is a need for a comprehensive and integrated site selection system for more than one category of user to interact with real estate information, and to visually compare multiple user inputs. Further, there is a need for such a system where the various users can create and/or edit their own submissions on the system and save such entered or edited information on the site. Still further, there is a need for the ability to display competitive bids to industrial site developers, but without revealing company identities.

Therefore, a heretofore unaddressed need still exists in the art to address the aforementioned deficiencies and inadequacies.

### SUMMARY OF THE INVENTION

In one aspect, the present invention relates to a computerized site selection system. In one embodiment, the system includes a representation means for generating visual representations of data to at least one user, an interface means having interactive user controls for manipulating data in response to an action by the at least one user, an analysis means for analyzing data, a communication means for sending and receiving data to and from the at least one user, a storage means for storing data saved by the at least one user, and a network server in communication with and programmed for controlling the functions performed by each of the representation means, interface means, analysis means, communication means, and storage means, where the data contains real estate information, and where at least one of the representation means, interface means, analysis means, and communication means is operatively associated with the at least one user through a network connection. The at least one user is at least one of a real estate client, real estate developer, real estate broker, data subscriber, and system administrator. The real estate information is associated with at least one real estate construction project and includes at least one of request-for-proposal, pricing model, pricing kit, project date, bid, and counterbid.

The interactive user controls are graphical user interface controls displayed on a computer screen. The visual representations generated by the representation means include at least one of graphs, charts, and numeric representations displayed on a computer screen.

In one embodiment, the system of claim further includes an access control means, for controlling access to at least one of the representation means, interface means, analysis means, communication means, and storage means, based upon the identity of the user as a real estate client, real estate developer, real estate broker, data subscriber, or system administrator. The network connection is an internet connection and at least one of the representation means, interface means, analysis means, and communication means is operatively associated with a user computer through a network connection. In this embodiment, a network connection is an internet connection and at least one of the representation means, interface means, analysis means, and communication means is a web-based application.

In another aspect, the present invention relates to a computerized site selection system. In one embodiment, the system includes a developer module operable for receiving, storing, and providing data in communication with at least one real estate developer, a client-broker module operable for receiving, storing, and providing data in communication with at least one real estate client or real estate broker, a client-broker transaction analysis module operatively associated with the client-broker module, operable for selectively providing developer-specific information to the at least one real estate client or real estate broker, a developer transaction analysis module operatively associated with the developer module operable for selectively providing project-specific information to at least one real estate developer, where the data contains real estate information and each of the developer module, client-broker module, client-broker transaction analysis module, and developer transaction analysis module is operatively associated with a corresponding at least one of the real estate developer, real estate client, and real estate broker through a network connection.

In one embodiment, the data provided by the client-broker module includes a request-for-proposal for a real estate construction project. The data also includes comprises a list of real estate developers eligible for bidding on a real estate construction project. The data received by the client-broker module includes real estate construction project information submitted by a real estate client or real estate broker that is accessible or inaccessible to a real estate developer as determined by the real estate client, real estate broker, or system administrator. The developer module is further operable for generating at least one visual representation of data associated with at least one real estate construction project for which the real estate client or real estate broker has designated as open for receiving bids or for which at least one bid has been placed. The data provided by the developer module includes at least one request-for-proposal for a real estate construction project that is operable to be downloaded by a real estate client or real estate broker. The data received by the real estate developer includes at least one completed request-for-proposal for a real estate construction project.

In one embodiment, each of the developer module, client-broker module, client-broker transaction analysis module, and developer transaction analysis module are operatively associated with a graphical user interface including controls for manipulating data in the system in response to an action by the at least one real estate developer, real estate client, or real estate developer. The client-broker module is further operable for providing interactive access to data associated with at least one real estate construction project provided by at least one real estate developer in response to a request-for-proposal. The data contains information associated with a real estate construction project and includes at least one of a pricing model, pricing kit, bid, counterbid, request-for-proposal, and the identity of at least one real estate developer. The client-broker transaction analysis module is operable for providing a visual side-by-side comparison of data containing two or more bids provided by two or more corresponding real estate developers.

In yet another aspect, the present invention relates to a method of using a computerized site selection system. In one embodiment, the method includes the steps of accessing the site selection system through a network connection and providing identification designating that the user is a real estate client or a real estate broker. The method further includes performing at least one of the steps of reviewing at least one open real estate construction project and corresponding at least one bid provided by an eligible real estate developer, creating a new real estate construction project, providing corresponding real estate information, and selecting, from a list of eligible real estate developers, at least one real estate developer to receive at least one bid from, selecting, from a list of eligible real estate developers that have provided at least one bid on an existing real estate construction project, a real estate developer and reviewing the corresponding bid, selecting at least one metric for comparing at least two bids received from at least two corresponding eligible real estate developers for the same real estate construction project and viewing a generated visual comparison of the bids based on the selected at least one metric; and selectively providing access to at least one eligible real estate developer to view at least one bid provided by at least one other eligible real estate developer for the same real estate construction project.

In one embodiment, the step of providing corresponding real estate information comprises the step of entering the real estate information on a web-based form, and the selected at least one metric comprises information associated with at least one of square footage, cost per square foot, taxes, fees, insurance, and base rental rate. In this embodiment, the entered real estate information includes at least one of a request-for-proposal, a start date for the real estate construction project, and an end date for the real estate construction project. The method further includes the steps of editing the entered information on a web-based form and storing the edited information.

In yet another aspect, the present invention relates to a method of using a computerized site selection system. In one embodiment, the system includes a presentation means for generating visual representations of data to at least one user, an interface means having interactive user controls for manipulating data in response to an action by the at least one user, an analysis means for analyzing data, a communication means for sending and receiving data to and from the at least one user, a storage means for storing data saved by the at least one user, and the network server in communication with and programmed to control the functions performed by each of the representation means, interface means, analysis means, communication means, and storage means. The data contains real estate information, and at least one of the representation means, interface means, analysis means, and communication means is operatively associated with the at least one user through a network connection. The method includes the steps of accessing the site selection system through the network connection and providing identification containing a designation that the user is a real estate developer. The method further includes performing at least one of the steps of receiving an association as an eligible real estate developer for bidding on at least one real estate construction project, viewing real estate information associated with at least one real estate construction project that is open for receiving bids, and selecting a real estate construction project from a list of real estate construction projects that are open for receiving bids and providing a bid corresponding to the selected real estate construction project. The real estate information comprises a request-for-proposal provided by a real estate client or real estate broker. In one embodiment, the step of providing a bid includes the step of entering real estate information on a web-based form. The step of providing a bid also includes the steps of selecting a property from a dynamic list of eligible real estate properties for a construction project and associating the selected property with at least one bid. The method also includes the step of storing the entered information in a storage means operatively associated with the web-based form. The method also includes the step of editing the entered real estate information on a web-based form.

In yet another aspect, the present invention relates to a method of using a computerized site selection system including a representation means for generating visual representations of data to at least one user, an interface means having interactive user controls for manipulating data in response to an action by the at least one user, an analysis means for analyzing data, a communication means for sending and receiving data to and from the at least one user, a storage means for storing data saved by the at least one user, and a network server in communication with and programmed to perform the functions performed by each of the representation means, interface means, analysis means, communication means, and storage means, where the data contains real estate information, and where at least one of the representation means, interface means, analysis means, and communication means is operatively associated with the at least one user through a network connection. In one embodiment, the method includes the steps of, if the at least one user is a real estate developer, accessing the site selection system through the network connection and providing identification containing a designation that the user is a real estate developer. The method further includes performing at least one of the steps of receiving an association as an eligible real estate developer for bidding on at least one real estate construction project, viewing real estate information associated with at least one real estate construction project that is open for receiving bids, selecting a real estate construction project from a list of real estate construction projects that are open for receiving bids and providing a bid corresponding to the selected real estate construction project.

In one embodiment, the method includes the steps of, if the at least one user is a real estate client or real estate broker, accessing the site selection system through the network connection and providing identification containing a designation that the user is a real estate client or real estate broker. The method further includes performing at least one of the steps of reviewing at least one open real estate construction project and corresponding at least one bid provided by an eligible real estate developer, creating a new real estate construction project, providing corresponding real estate information, selecting, from a list of eligible real estate developers, at least one real estate developer to receive at least one bid from, selecting, from a list of eligible real estate developers that have provided at least one bid on an existing real estate construction project, a real estate developer and reviewing the corresponding bid, selecting at least one metric for comparing at least two bids received from at least two corresponding eligible real estate developers for the same real estate construction project and viewing a generated visual comparison of the bids based on the selected at least one metric, and selectively providing access to at least one eligible real estate developer to view at least one bid provided by at least one other eligible real estate developer for the same real estate construction project.

In yet another aspect, the present invention relates to a method of using a computerized site selection system including a representation means for generating visual representations of data to at least one user, an interface means having interactive user controls for manipulating data in response to an action by the at least one user, an analysis means for analyzing data, a communication means for sending and receiving data to and from the at least one user, a storage means for storing data saved by the at least one user, and a network server in communication with the representation means, interface means, analysis means, communication means, and storage means, where the network server is programmed for controlling the functions performed by each of the representation means, interface means, analysis means, communication means, and storage means, where the data contains real estate information, and where at least one of the representation means, interface means, analysis means, and communication means is operatively associated with the at least one user through a network connection. In one embodiment, the method includes at least one of the steps of causing the representation means to generate a visual representation of data, causing the interactive user controls of the interface means to manipulate data, causing the analysis means to analyze data, causing the communication means to send and receive data, and causing the network server to communicate with at least one of the representation means, interface means, analysis means, communication means, and storage means, and to control each function of the representation means, interface means, analysis means, communication means, and storage means.

In yet another aspect, the present invention relates to a method of using a computerized site selection system, including a developer module operable for receiving, storing, and providing data in communication with at least one real estate developer, a client-broker module operable for receiving, storing, and providing data in communication with at least one real estate client or real estate broker, a client-broker transaction analysis module operatively associated with the client-broker module, operable for selectively providing developer-specific information to the at least one real estate client or real estate broker, and a developer transaction analysis module operatively associated with the developer module operable for selectively providing project-specific information to at least one real estate developer, where the data contains real estate information and each of the developer module, client-broker module, client-broker transaction analysis module, and developer transaction analysis module are operatively associated with the corresponding at least one real estate developer, real estate client, and real estate broker through a network connection. In one embodiment, the method includes at least one of the steps of causing the developer module perform at least one of the functions of receiving data, storing data, and providing data, causing the client-broker module to perform at least one of the functions of receiving data, storing data, and providing data, causing the client-broker transaction analysis module to selectively provide developer-specific information, and causing the developer transaction analysis module to selectively provide project-specific information.

In yet another aspect, the present invention relates to software stored on a computer-readable medium for causing a computing system to perform functions for interacting with at least one user of a site selection system. In one embodiment, the functions include generating visual representations of data to the at least one user, manipulating data in response to an action by the at least one user, analyzing data, sending and receiving data to and from the at least one user, and storing data saved by the at least one user, where the data contains real estate information and at least one of the functions of generating visual representations, manipulating data, sending and receiving data, and storing data occurs through a network connection.

In yet another aspect, the present invention relates to software stored on a computer-readable medium for causing a computing system to perform functions for interacting with at least one user of a site selection system. In one embodiment, the functions include receiving, storing, and providing data in communication with at least one real estate developer, receiving, storing, and providing data in communication with at least one real estate client or real estate broker, selectively providing developer-specific information to the at least one real estate client or real estate broker, and selectively providing project-specific information to the at least one real estate developer, where the data contains real estate information and each of the functions of receiving data, storing data, providing data, selectively providing developer-specific information, and selectively providing project-specific information occurs through a network connection.

In yet another aspect, the present invention relates to a method of using software stored on a computer-readable medium for causing a computing system to perform functions for interacting with at least one user of a site selection system. In one embodiment, the method includes the steps of accessing the site selection system through a network connection, providing identification containing a designation that the user is a real estate developer, receiving data, storing data, providing data, and receiving project-specific information, where the data contains real estate information and each of the steps of receiving data, storing data, providing data and receiving project-specific information occur through an internet connection.

In yet another aspect, the present invention relates to a method of using software stored on a computer-readable medium for causing a computing system to perform functions for interacting with at least one user of a site selection system. In one embodiment, the method includes the steps of accessing the site selection system through an internet connection, providing identification containing a designation that the user is a real estate client or real estate broker, receiving data, storing data, and providing data, and receiving developer-specific information, where the data contains real estate information and each of the functions of receiving data, storing data, providing data, and receiving project-specific information occurs through an internet connection.

These and other aspects of the present invention will become apparent from the following description of the preferred embodiments taken in conjunction with the following drawings, although variations and modifications therein may be affected without departing from the spirit and scope of the novel concepts of the disclosure.

### BRIEF DESCRIPTION OF THE DRAWINGS

FIG. 1A shows schematically a site selection system according to one embodiment of the present invention and the relationship between various users, storage means, and a network server for the site selection system, according to one embodiment of the present invention.

FIG. 1B shows schematically the relationship between various users and a communication means for a site selection system, according to one embodiment of the present invention.

FIG. 2A shows a flow chart illustrating steps of a method for using a computerized site selection system for a user in the role of a real estate developer, according to one embodiment of the present invention.

FIG. 2B shows a flow chart illustrating further steps of the method as shown in the flow chart of FIG. 2A, according to one embodiment of the present invention.

FIG. 2C shows a flow chart illustrating further steps of the method as shown in the flow chart of FIG. 2B, according to one embodiment of the present invention.

FIG. 3A shows a flow chart illustrating steps of a method for using a computerized site selection system for a user in the role of a real estate client or real estate broker, according to one embodiment of the present invention.

FIG. 3B shows a flow chart illustrating further steps of the method as shown in the flow chart of FIG. 3A, according to one embodiment of the present invention.

FIG. 3C shows a flow chart illustrating further steps of the method as shown in the flow chart of FIG. 3A, according to one embodiment of the present invention.

FIG. 4 shows schematically an interface means for performing steps of the method as shown in the flow chart of FIG. 2C, according to one embodiment of the present invention.

FIG. 5A shows schematically an interface means for performing steps of the method as shown in the flow chart of FIG. 3C, according to one embodiment of the present invention.

FIG. 5B shows schematically a further illustration of the interface means shown in FIG. 5A, according to one embodiment of the present invention.

FIG. 5C shows schematically a further illustration of the interface means shown in FIGS. 5A and 5B, according to one embodiment of the present invention

FIG. 6A shows schematically a graphical representation generated according to steps of the method as shown in the flow chart of FIG. 3C, according to one embodiment of the present invention.

FIG. 6B shows schematically another graphical representation generated according to steps of the method as shown in the flow chart of FIG. 3C, according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention. Additionally, some terms used in this specification are more specifically defined below.

### DEFINITIONS

The terms used in this specification generally have their ordinary meanings in the art, within the context of the invention, and in the specific context where each term is used.

Certain terms that are used to describe the invention are discussed below, or elsewhere in the specification, to provide additional guidance to the practitioner in describing the apparatus and methods of the invention and how to make and use them. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the invention or of any exemplified term. Likewise, the invention is not limited to various embodiments given in this specification. Furthermore, subtitles may be used to help a reader of the specification to read through the specification, which the usage of subtitles, however, has no influence on the scope of the invention.

### OVERVIEW OF THE INVENTION

The description will be made as to the embodiments of the present invention in conjunction with the accompanying drawings. In accordance with the purposes of this invention, as embodied and broadly described herein, this invention, in one aspect, relates to a computerized site selection system 100.

The site selection system supports many different types of business entities, which equate to different categories of users for the system, and various relationships are supported. One category of user is a real estate developer (hereinafter also referred to as “developer.” There can be more than one developer who bids on a given real estate construction project (hereinafter also referred to as “project,”) and each developer may submit one or more bids for a given project. In a given market, such a developer might offer three separate bids which satisfy a request-for-proposal (RFP) for a single project, for example. Another supported category of user is a real estate broker (hereinafter also referred to as “broker,”) that can serve as an intermediary party between a real estate client and a real estate developer. A user in the role of a real estate broker has the same privileges and role behavior as a real estate client (hereinafter also referred to as “client”). A real estate client is the responsible party for a real estate construction project, which can be a business or other agency seeking competitive bids for the construction of an industrial facility. A real estate construction project is, for example, an industrial construction site which is under bid by more than one bidder, and a real estate developer becomes a bidder once he or she has formally entered the bidding process, which occurs when a broker selects them as a bidder. A real estate construction project has associated details and attributes, such as start date or end date for receiving bids from eligible real estate developers. In addition, each real estate project can consist of one or more real estate properties and sites, such as specific existing buildings, that are defined by the developer as his or her proposed solution to the specific needs of the real estate client, as outlined in the request-for-proposal. Each real estate construction project has one or more sites and/or properties that may be presented to a real estate client. This refers to a physical location having associated qualities such as taxable value and total square footage. Only fixed qualities, i.e., aspects that will not vary by model, are attributes of a site. For example, the location and square footage for a site is not dynamic. A model is the combination of variables used in the execution of a what-if scenario. For example, one model might assume an insurance rate of eight cents per square foot and a tax rate of twelve cents. This is not fixed, but varies according to what the bidder is testing while developing his bid. An assumption that applies here is that a single model should yield a single value for cost per square foot (CPSF). However, the model itself can depend upon the variables and particular details associated with the real estate developer and the real estate construction project.

In one embodiment, the system uses a publicly available web site that is accessible by a URL entered by a user into his or her internet browser. The home page contains general information regarding the purpose of the tool and any other marketing material deemed desirable. In addition, the home page provides links to enable real estate brokers and other proprietary users (e.g. real estate developers, real estate clients) to access, via a secure connection, the actual site selection tool. A user in the real estate broker role can use a project creation screen that serves as a starting point for submitting information regarding a new project and the details surrounding it. A web form captures entered information from the user, including request-for-proposal documents, data associated with selection of developers, and a collection of other pertinent information such as rental rates, and project values. In terms of compatible internet browsers for using the system, Firefox® and Internet Explorer® are fully supported on the Windows® operating system. Firefox®, Safari® and Internet Explorer are fully supported on the Mac® OS X operating system. Those web pages constituting the Site Selection Tool are run under Secure Sockets Layer (SSL), the same encryption scheme used on virtually every Internet site that traffics in sensitive financial, business or personal information.

In one embodiment, displayed data is stored (hereinafter also referred to as “saved”) as spreadsheets, such as in the form of Excel® files, which are structured in order to display particular aspects of a construction bid for a specific real estate site (e.g. an industrial site), using total square footage and cost per square foot (CPSF) as key metrics. Although total square footage is fixed, CPSF varies depending on site-specific taxes, fees, insurance and, and other variable costs, all of which modify the base rental rate. It is the base rental rate which accounts for most of the cost used in computing the CPSF, and this is a key metric used by developers and clients in pricing a project.

A user in either the real estate broker or real estate client role can log-in to the system and view all of the eligible real estate developers, pricing models, and other project details uploaded by one or more developers for any projects within their portfolio. This includes the ability to view bids that have not been marked as final by a developer. A transaction analysis module provides a visual, side-by-side comparison of the various developer bids. In one embodiment of the system, as the real estate client or real estate broker moves a computer cursor over a particular detail, the user interface displays the respective real estate developer and the actual quantity/amount in a pop-up-type window.

A user in the developer role can log-in to the system and view a list of his or her associated real estate construction projects, which can be organized, for example, as a tree view showing projects with an open invitation to receive a bid, and those for which a bid has been placed. The developer may select a specific real estate construction project and electronically download its request-for-proposal, then complete the required information and upload it, either in the same session or at a later time. The request-for-proposal can be processed on a web server and the contents incorporated into the transaction analysis module for the real estate developer. In one embodiment, the request-for-proposal includes an Excel® file containing the specific data input captures needed by the system for building the comparison model associated with the transaction analysis module. After uploading the file with completed information, the developer can then see his or her bid information within an interactive form loaded into a web browser.

The developer can then make adjustments/edits to the data provided, using various user interface controls. These controls perform real-time calculations in response to the user inputs, updating the appropriate fields accordingly. In addition, the user has the option to save any changes and revisit them later. In one embodiment, this action is explicit and is not an automatic event in response to the changing of a control. This may be particularly used in scenarios where the real estate developer wishes to gather additional information concerning available options for creating the most competitive bid for a given real estate construction project. These activities take place in one or more sessions before the developer chooses to submit/provide his bid for final consideration. Bids marked final are locked from any further edits and are considered binding offers. When the real estate developer submits a final bid, the appropriate real estate client and/or broker are sent an email notification. However, the client is able to view saved bid data throughout the lifecycle of a developer/project bid process. This means that the client and broker do not have to wait until a bid is marked final before reviewing its associated details. In one embodiment, no information concerning other bidders or their bid details is visible to the developer.

Request-for-proposals can be Word or Adobe® PDF documents containing detailed, variable requirements for a real estate construction site. The site selection system's general purpose, minimum allocations for space based on functions, and structural requirements, among other aspects, are expressed in the RFP's. These files are electronically uploaded via the internet browser and then stored on a secure file storage system that is not directly accessible over the internet The system itself, in one embodiment, is not responsible for editing, manipulating or indexing any uploaded materials. With regard to selection of real estate developers, this can take place from a list of developers that the user can invite as bidders (i.e. a user in the role of a real estate developer that provides/submits one or more bids for a particular real estate construction project. These bidders in turn receive electronic notification when a new real estate construction project has become available and the bidders can respond accordingly. For example, the bidders can log into the website and download one or more files such as documents with specific information about the real estate construction project. They can also call or email a contact with specific questions, based on the information received or viewed. As stated above, the web form for the project creation screen also can capture a collection of other pertinent information such as rental rates, project values, entered or edited in the form of data containing the relevant information.

The real estate developer, in one embodiment, can select one or more real estate properties and associate those properties with a particular bid. That is, one or more available/eligible properties can be selected from a dynamically updated list, such as from a property database, and tied to one or more particular bids by that developer. In one embodiment, when a given real estate property is selected from the list, this triggers the opening of a transaction analysis module, which is used to set and adjust specific properties of a bid and submit the bid for review by a real estate client or real estate broker. For example, the real estate developer can select a a particular building can be selected from the list of eligible properties and placed into the response to the request-for-proposal.

In one embodiment, a client or broker can submit, in response to a received bid from a developer, a counterbid. Using graphical user interface controls in the transaction analysis module, the client or broker can make dynamic adjustments to the bids received from at least one developer, and can also add custom metrics into custom input data fields, to be factored into the financial considerations of reviewing a bid and/or submitting a counterbid. The client or broker can thus enter cost variables that are associated with each particular real estate property, such as a particular building. These added custom metrics can be factored into aggregate cost models that consequently present a more broad view of the financial considerations associated with a given bid. A real estate client or real estate broker using the transaction analysis module may enter one or more cost variables associated with a particular proposed real estate property, and another set of one or more cost variables associated with a second particular real estate property. The cost variables may include, for instance, lost business or labor variance. Because the client or broker can view the results of how the custom cost variables affect the aggregate total costs for the given construction project, the client or broker then effectively has a more broad field of view of the financial considerations for the project, as compared to the more narrow view allowed to the developer, who does not have access to view the client/broker's custom input variables. That is, when a counterbid is submitted back to one or more developers for a given construction project, the developer can only review the standard real estate metrics and resulting output charts or graphs, but not any custom considerations added by the client or broker.

A user in any one of the roles of real estate client, real estate broker, or real estate developer can view stored data on his or her previously placed bids/counterbids, before and after another round of bids or counterbids is placed, for instance, such that the user may view the progression or trends in bidding over a period of time. There can be more than one round of bidding/counterbidding that takes place between the real estate client or real estate broker and the developer. Also, the amount of bids that a given developer submits for a given real estate construction project is not limited, nor is the amount of real estate properties (e.g. buildings) that the developer may select to associate with a given real estate construction project.

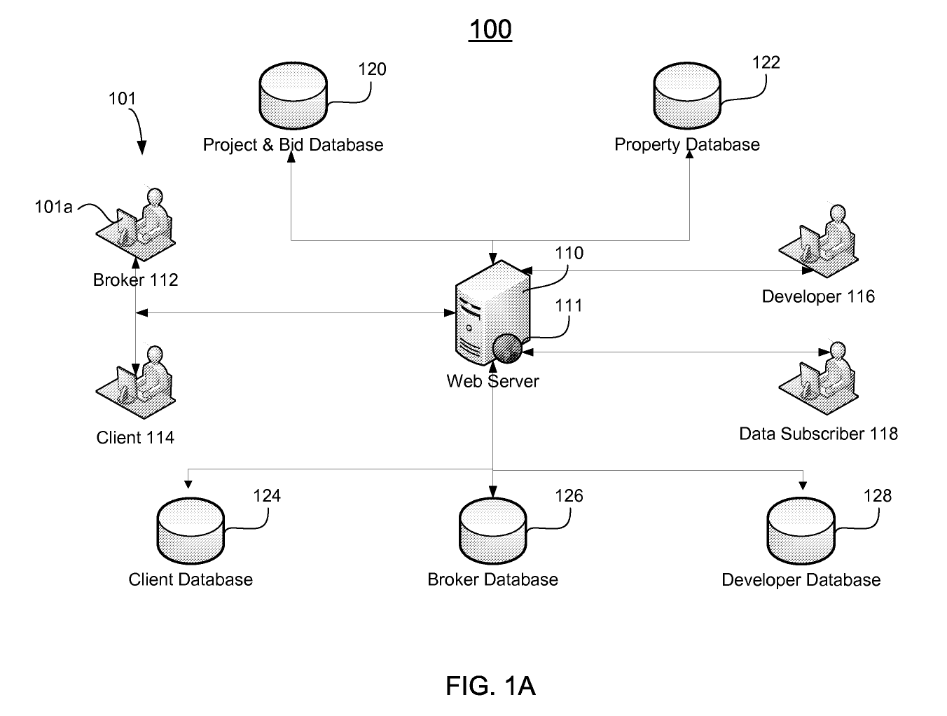

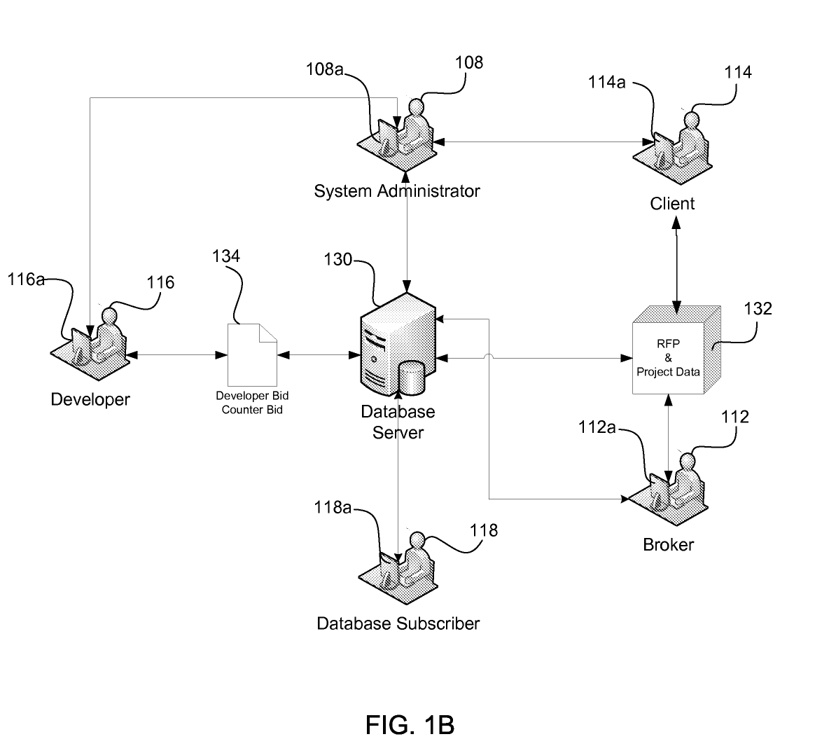

Now referring specifically to FIGS. 1A and FIG. 1B, FIG. 1A shows schematically a site selection system 100 and the relationship between various users 112-118, storage means 120-128, and a network server 110 for the site selection system 100, according to one embodiment of the present invention. Users 112-118 include a real estate broker 112, real estate client 114, real estate developer 116, and data subscriber 1 18. Each of the users 112-118 is connected to the network server 110, which in the embodiment shown is an internet web server having an internet connection 111. The storage means 120-128 includes a project and bid database 120, property database 122, client database 124, broker database 126, and developer database 128. In one embodiment, each of these databases 120-128 operate independently from each other, such that custom reports can be compiled to fit the specific requests or needs of a real estate client or real estate broker. That is, the data can be selectively aggregated in various custom ways. In one embodiment, a real estate broker can view one or more specific buildings and specifically determine what bids had been placed on that building in a recent time period, such as for the preceding ten years.

FIG. 1B shows schematically the relationship between various users 108, 112-118 and a communication means 130 for a site selection system, according to one embodiment of the present invention. As shown, in addition to the real estate broker 112, real estate client 114, real estate developer 116, and database subscriber 118, a system administrator 108 is connected to the site selection system 100, and each of these users 108, 112-118 are further connected to a communication means 130, which here is a database server for entering, storing, and retrieving real estate information such as a developer bid or counterbid 134, or a request-for-proposal and/or other project data 132, to and from each one of the users 108, 112-118 in connection with the network server 110 and storage means 120-128 shown in FIG. 1A.

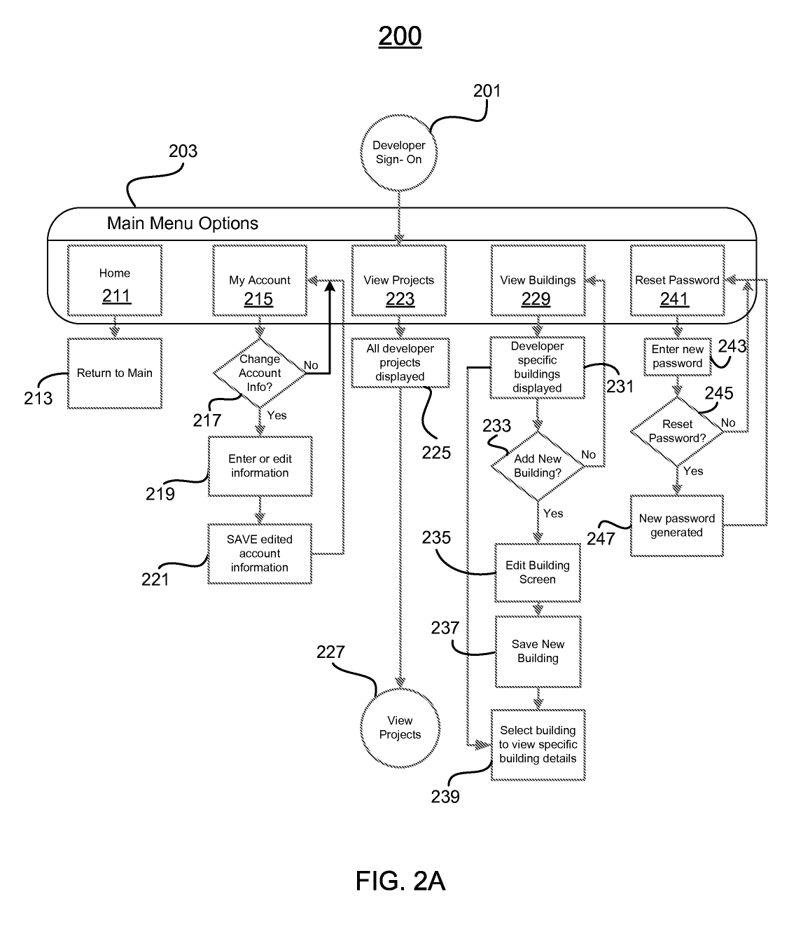

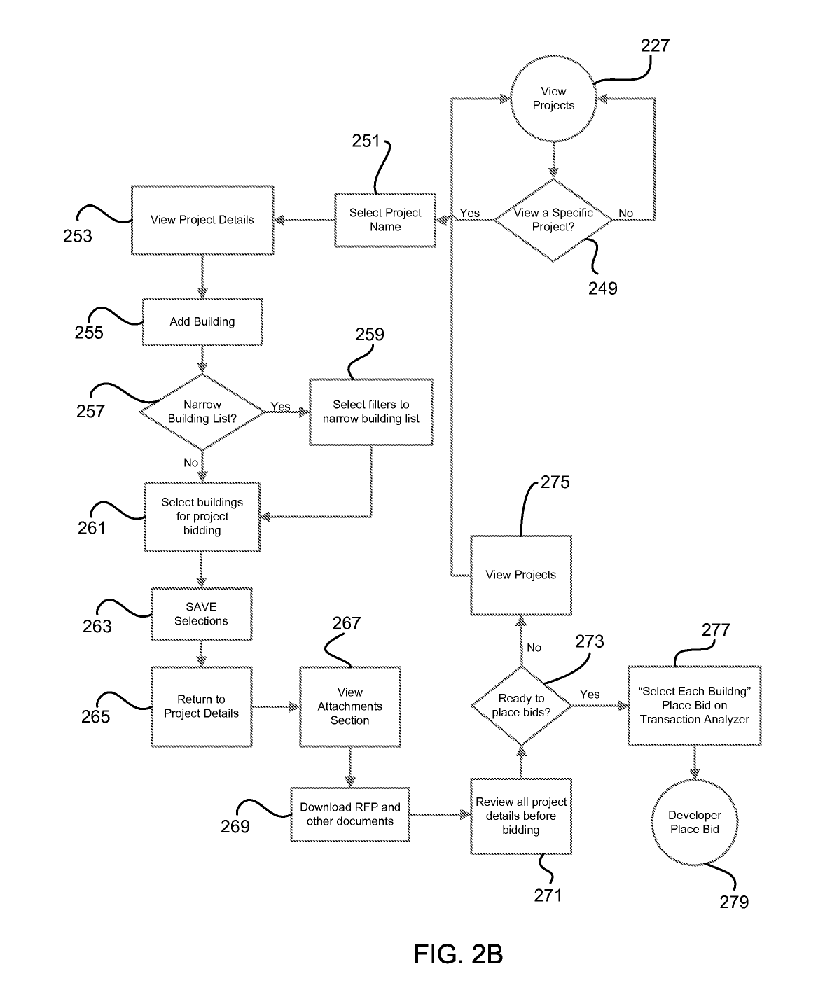

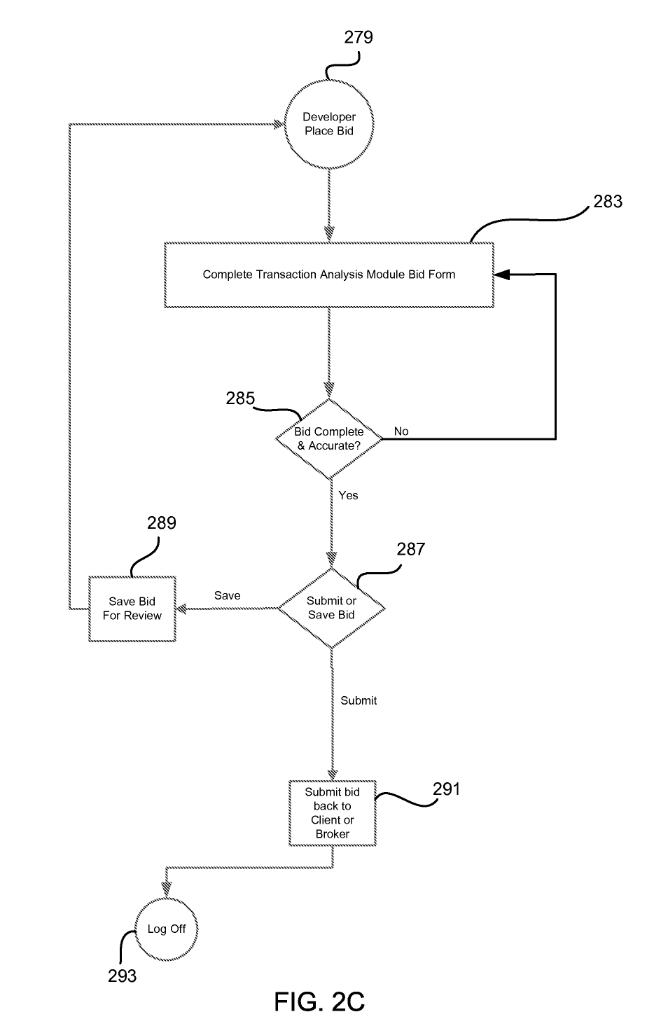

Now referring to FIGS. 2A-2C, FIG. 2A shows a flow chart 200 illustrating steps of a method for using a computerized site selection system for a user in the role of a real estate developer, according to one embodiment of the present invention. At step 201 (“Developer Sign-On”), the site selection system is accessed through a network connection, which in this example is an internet connection (see FIG. 1A and FIG. 1B), and identification is provided containing a designation that the user is a real estate developer. From the main menu options screen at step 302, the method proceeds to one of step 213, which returns to the main site selection system interface screen(s) (“Home”), step 215, where user account information is edited (“My Account”), step 223, where at least one real estate construction project is viewed (“View Projects”), step 229, where at least one eligible real estate property is viewed (“View Buildings”), or step 241, where a password is reset (“Reset Password”). Each of the steps in this embodiment is performed on a web-based application.

The step of editing user account information 215 includes the step of editing account information, such as data containing user contact information, which can be entered and/or edited at step 219, and the step 221 of saving (hereinafter also referred to as “storing” or corresponding to saved data) the newly entered or edited data. Now referring also to the flowchart of FIG. 2B, the step of viewing one or more construction projects 223 (“View Projects”) further includes the steps 225 and 227 of viewing one or more real estate construction projects associated with that user, and steps 249 and 251 where a real estate construction project is selected according to project name. At step 253, data associated with the selected real estate construction project is viewed, where the data contains project details, such as one or more of a real estate client name, real estate construction project name, type of property, lease term, commissions, start date, end date, project summary, property location, and/or information associated with a request-for-proposal. At step 255, a list populated with at least one eligible real estate property is viewed. The list has at least two eligible real estate properties, such as available buildings that can be used to fulfill the specific needs for completing a real estate construction project as outlined in the request-for-proposal, and at steps 257 and 259, the list is sorted according to at least one criteria. This sorting step can include searching the property database 122 (see FIG. 1A, FIG. 1B) for matching properties and narrowing down the list according to the selected criteria. The property database 122 is regularly updated to maintain accurate and timely real estate information regarding each property. At step 261, at least one eligible real estate property is selected from the list, to be provided with a bid for a selected real estate construction project, at step 261, and at step 263 the data associated with the selected at least one real estate property is stored in a storage means. When a user is in the role of a data subscriber, he or she has limited access to the site selection system 100, but can access this dynamic list of real estate properties and associated data. This can set up as a subscription-type fee arrangement between the operator of the site selection system, for instance. Also, the access rights assigned for each category of user can be controlled and changed by one or more of the users of the system, such as by the system administrator 108.

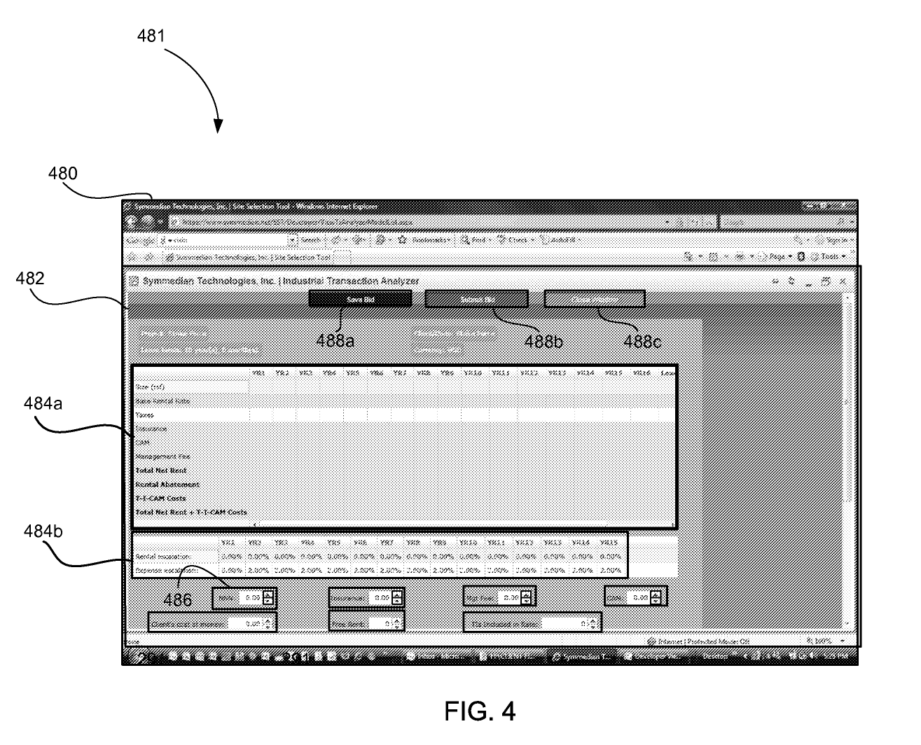

As shown in steps 265-269 of FIG. 2B, the selected real estate construction project includes an electronic attachment, where at step 269, the electronic attachment is selected and downloaded. The electronic attachment, in one embodiment, is a request-for-proposal 269 from a real estate client or real estate broker. At step 229 (“View buildings”), data associated with one or more eligible real estate properties is viewed, that are associated with the user with, at steps 231 and 239. The eligible real estate properties can include, for example, a building that the user-developer will propose to use to complete the requirements for the particular construction project, as laid out in a request-for-proposal from a real estate client or real estate broker. At step 233, a new real estate property can be added, and data associated with the new real estate property is entered and/or edited at step 235 and stored at step 237. Now referring also to the flow chart of FIG. 2C and the schematic illustration of the interface means in FIG. 4, the method further includes providing a bid for the selected real estate construction project, corresponding to steps 271-279. At step 271, project details are reviewed before one or more bids are placed for a selected real estate construction project or projects. From step 273, one or more properties can be selected for bidding on, at step 277. Alternatively, if one or more bids are not ready to be placed, the method returns to the “view projects” step 275. The step 279 of providing a bid for the selected real estate construction project, includes the step 282 of viewing a visual representation of a transaction analysis module (482 in FIG. 4) and the step 280 of entering data associated with the bid into the transaction analysis module using a graphical user interface (480 in FIG. 4), which also corresponds to step 283 in FIG. 2C. At step 285 the completeness and accuracy of a bid prepared using the transaction analysis module is reviewed, and at steps 287 and 291, a complete and accurate bid is submitted for review by at least one real estate client or real estate broker. At step 289, the bid is saved for internal review.

Now referring specifically to FIG. 4, in one embodiment, the transaction analysis module 482 is a web-based application displayed in a Windows® operating system on the user's computer screen 481. The data associated with the bid, as shown in the chart of FIG. 4, includes at least one of a rate, CAM, rent, and tax, which can be analyzed with more piece of data in a chart-form, extended out along a selected time period projection, as shown in 484a and 484b. The chart of 484b, for example, shows rental escalation and expense escalation over a 15-year period. The controls 486 are shown as adjustable active boxes running in the Windows® operating system, for making dynamic adjustments to the bid details, which can accordingly change the visual representations shown on the screen in response to interaction with a user. In addition, the functions of saving a bid, submitting a bid, and/or closing the transaction analysis module window can be accomplished by interacting with (e.g. clicking-on), the boxes 488a, 488b, and/or 488c, respectively. At step 289, data is stored that is associated with the bid. At step 293, a user is logged-off.

Also, from the “main menu options” screen at step 203, the user password can be reset at step 243, where a new user password is entered, and the user password is reset at step 245. At step 247, a confirmed new user password is received.

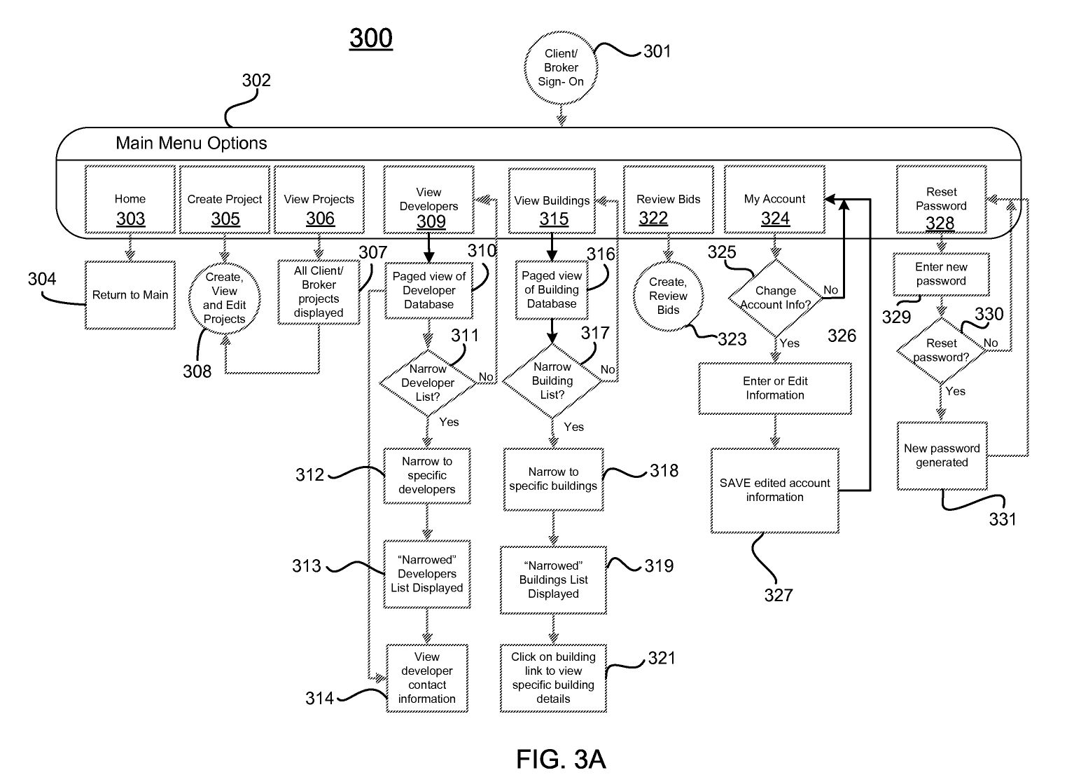

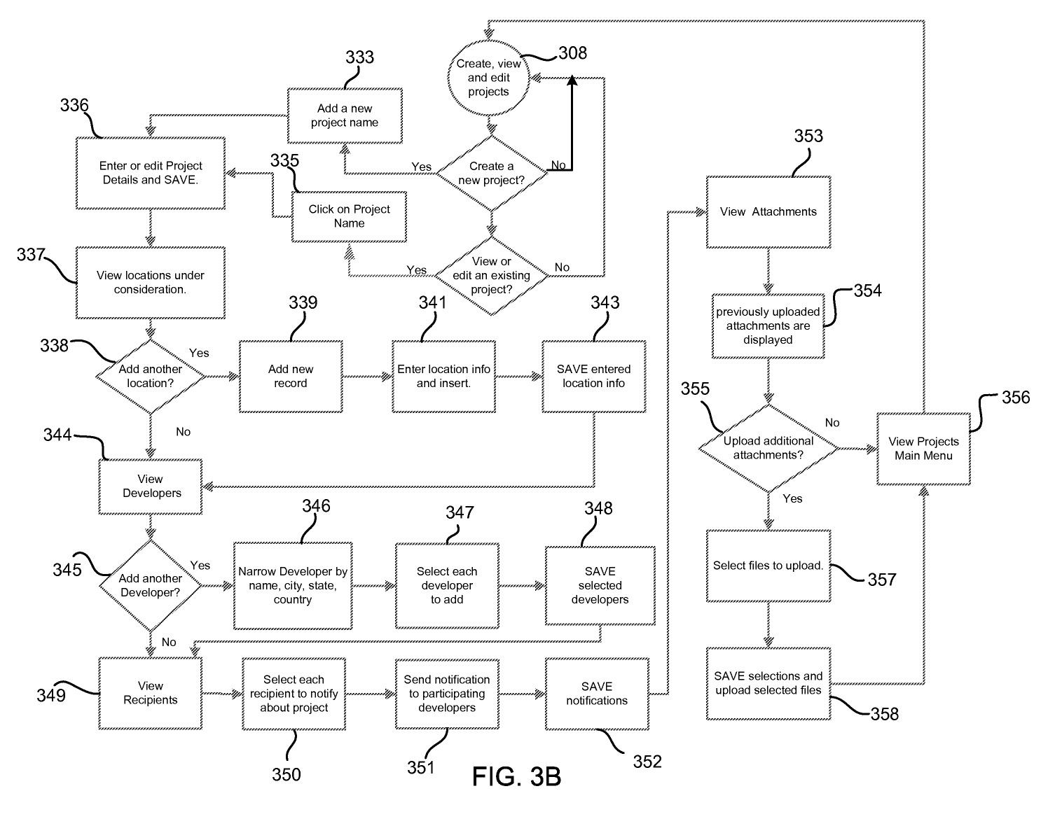

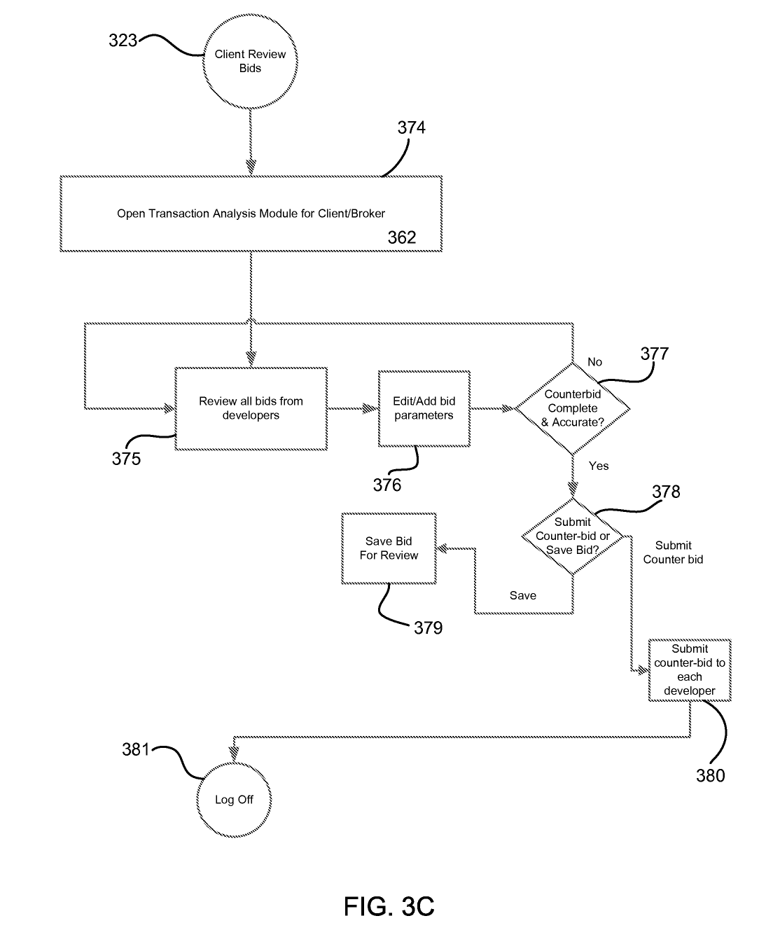

FIGS. 3A-3C show a flow chart 300 illustrating steps of a method for using a computerized site selection system for a user in the role of a real estate client or real estate broker, according to one embodiment of the present invention. At step 301 (“Client/Broker Sign-On”) of the method, the site selection system is accessed through a network connection (see FIGS. 1A and 1B), which in this example is an internet connection, and identification containing a designation that the user is at least one of a real estate client or real estate broker is provided, using a web-based form. At step 302 (“Main Menu Options”), the method proceeds along one of several options for the user to choose, on a web-based application. At step 305 (“Create Project”), a new real estate construction project is created. At step 306 (“View Projects”), an existing real estate construction project is viewed, and at step 309 (“View Developers”), at least one eligible real estate developer is viewed. At step 315 (“View Buildings”), at least one eligible real estate property is viewed, and at step 322 (“Review Bids”), at least one bid associated with a real estate construction project or projects is reviewed. At step 324 (“My Account”), user account information is edited, and at step 328 (“Reset Password”), a user password is edited using a web-based form.

From step 305 of the method of using the site selection system, for a user in the role of a real estate client or real estate broker, at step 308 a new real estate construction project is created, viewed, and/or edited (see details in flow chart of FIG. 3B). From step 306, one or more of the construction projects associated with the user can be viewed, where all the real estate client or real estate broker projects are displayed at step 307, and at step 308, an existing project is viewed and/or edited.

As shown in the flow chart of FIG. 3B, from step 308 (“View Projects Screen”), a new project is created at step 332, and at step 333, a corresponding project name is added. At step 334, if an existing project is to be viewed and/or edited, then at 335, a specific project is selected according to its corresponding project name. From either step 333 or step 335, project details can be entered and/or edited and stored, at step 336. Alternatively, from step 333 or 335, at least one real estate location can be viewed, at step 337, or at least one developer can be viewed at step 344. Still further, from step 333 or step 335, at least one recipient can be viewed at step 349, or at least one attachment is viewed at step 353. Note that the method does not have to follow the particular order of performing steps 336, 337, 344, 349, and 353 shown in the embodiment of FIG. 3B. That is, each of these steps can be performed in a different order, such as where each of steps 336, 337, 344, and 353 are options that can be selected one at-a-time by the user using graphical interface controls, such as a tab corresponding to each.

At step 336, details associated with a specific real estate construction project are viewed and/or edited, and then can be stored. At step 337, at least one real estate location is viewed, and from this step, at step 338 another location can be added. This includes performing steps 339-343, in which at step 339 a new record is selected to be added, at step 341, data is entered that is associated with the new location, using a web-based form, and at step 343, the entered data is stored. At step 344 in FIG. 3B, at least one eligible real estate developer for receiving a request-for-proposal and submitting at least one bid for the proposed real estate construction project, is viewed. From step 344, at step 345 at least one new real estate developer 345 is added. From step 345, at step 346 a list of eligible real estate developers is sorted by at least one criteria such as developer name, city, state, and country. At step 347, at least one eligible real estate developer is selected from the sorted list and is added as a new real estate developer, and at step 348 the selected at least one developer is stored. From step 349, where at least one recipient for a request-for-proposal is viewed, at step 350 at least one eligible real estate developer is selected, and at step 351 the selected developer is notified about the real estate construction project(s). The notification is stored at step 352. From step 353, at least one electronic attachment is viewed at step 354, where the electronic attachment, can be, for example, a request-for-proposal that is an electronic document, such as a Word file. From step 355, more attachments can be uploaded through selecting files to electronically upload, at step 357, and saving selected attachments and electronically uploading them at step 358. If no more attachments are to be uploaded, at step 356 the method returns to the main view projects main menu.

From step 309 shown in FIG. 3A, at step 310, data that is associated with the at least one eligible real estate developer is retrieved from a developer database, which can be viewed in a paged view. The data can be retrieved, for example, from the developer database 128 shown in FIG. 1A. The data associated with the at least one eligible real estate developer can include contact information and/or a list of eligible real estate developers, and the method further includes the steps of sorting the list according to at least one criteria and viewing the sorted list, corresponding to steps 311-313, where the list displays a sorted list of developers. At step 314 developer contact information is viewed.

From step 315, at step 316 least one eligible real estate property is viewed, which can be a paged view of retrieved data associated with the at least one eligible real estate property, from a property database, such as, for example property database 122 in FIG. 1A. From step 317, at step 318 the list of properties is sorted according to at least one criteria, and the sorted listing of eligible properties is displayed at step 319. From step 319, at step 321 specific details associated with a selected building can be viewed.

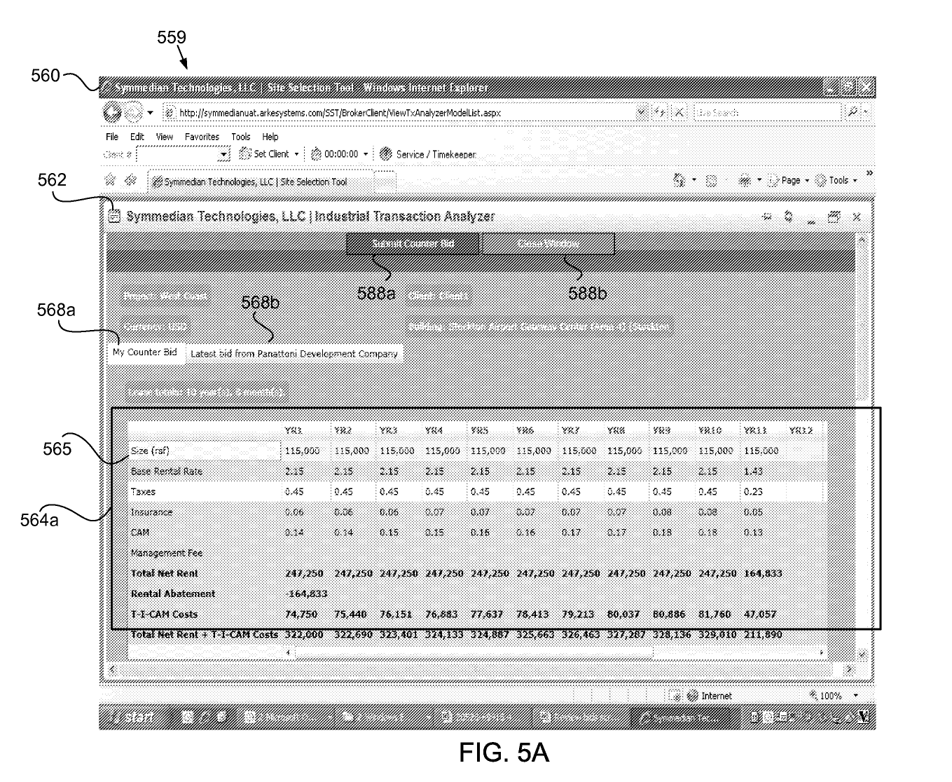

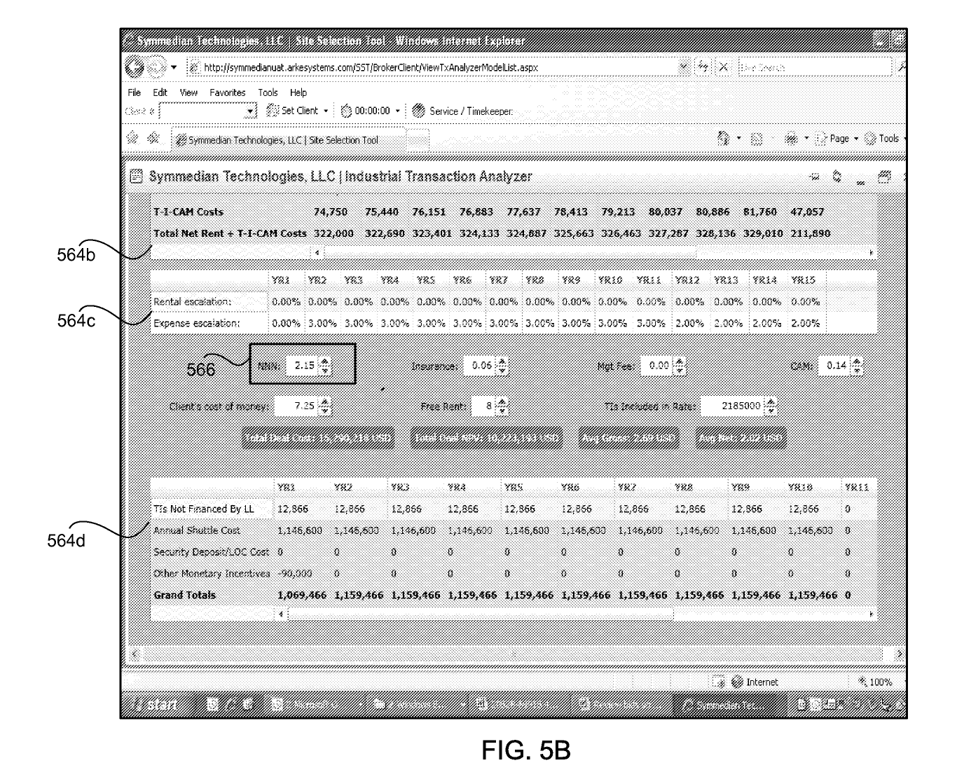

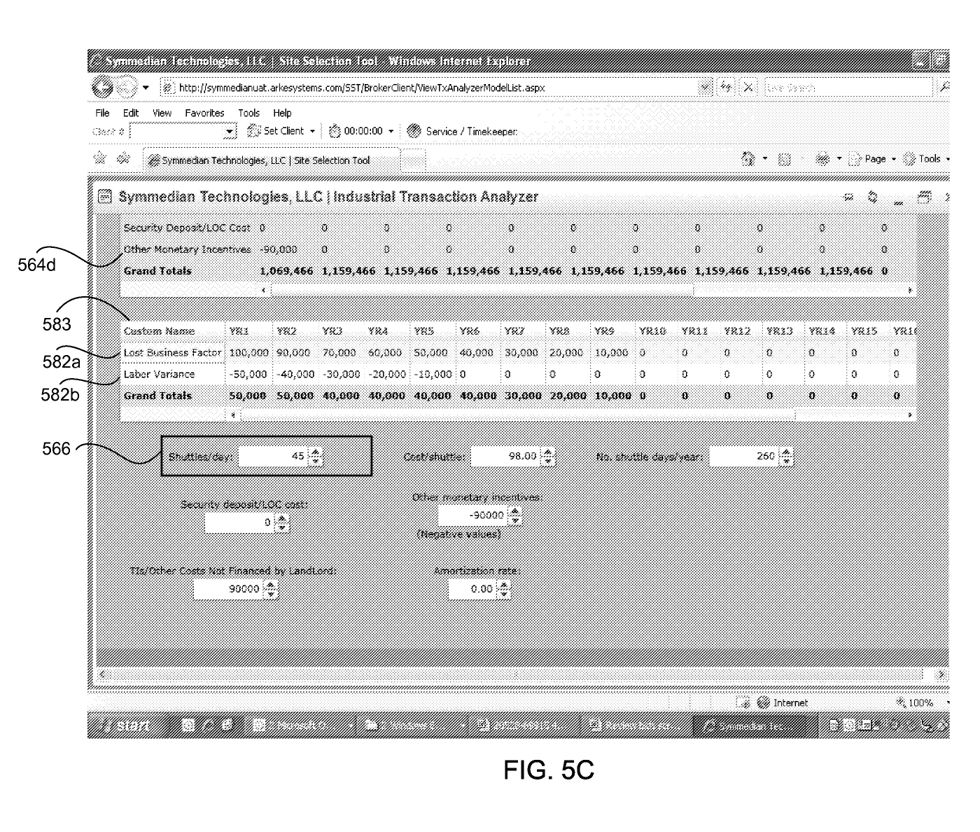

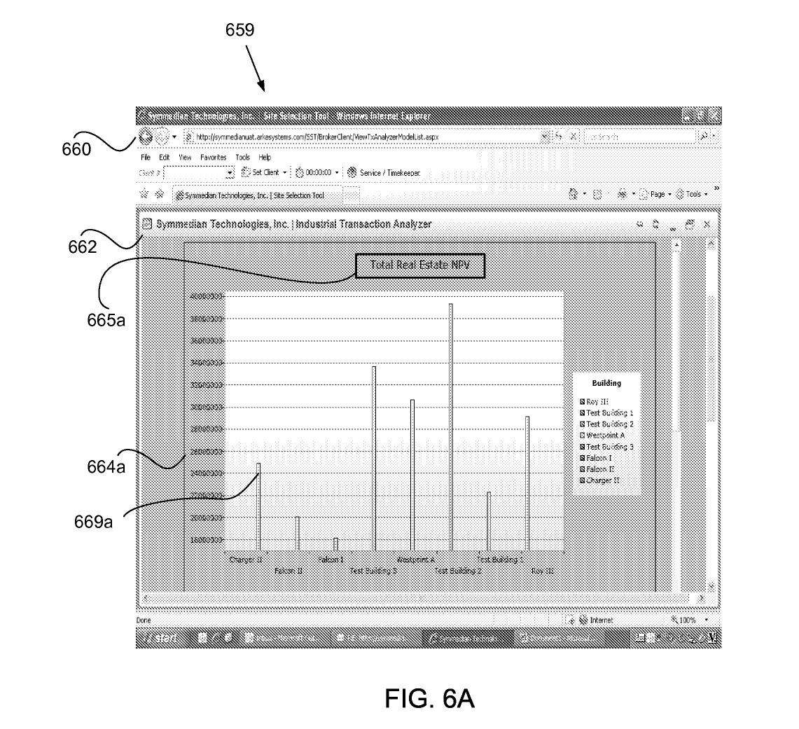

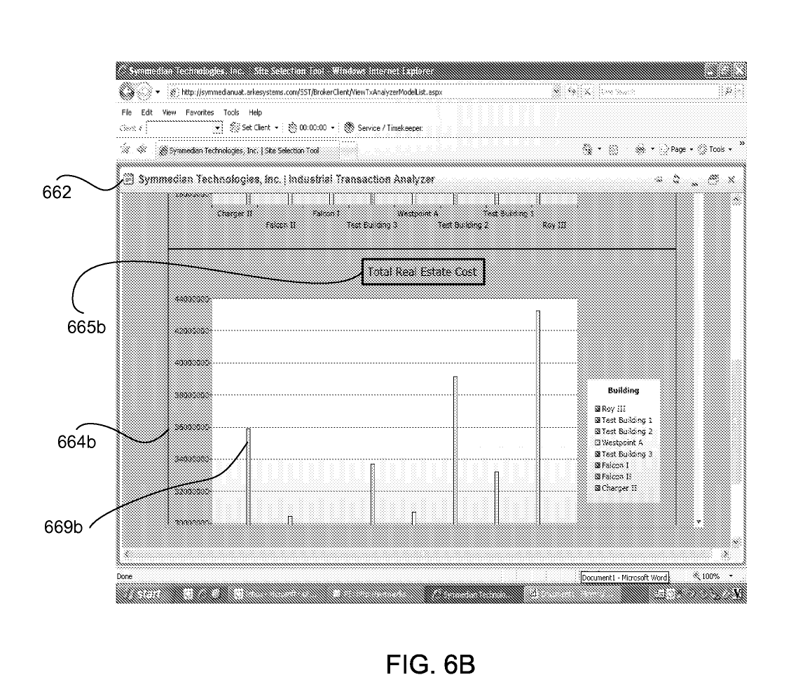

From step 322, corresponding to the step of reviewing at least one bid provided by at least one real estate developer, at step 323 (“Client Review Bids,” see also FIG. 3C), the transaction analysis module 562 (FIGS. 5A-5C) for real estate clients or real estate brokers is opened at step 374. At step 375, at least one bid provided by a real estate developer is selectively reviewed, and this can include selectively viewing a visual comparison for a plurality of bids provided by a corresponding plurality of real estate developers. Now referring specifically to FIGS. 6A and 6B, in one embodiment, a real estate broker or real estate client can select one or more metrics 665a, 665b for comparing multiple bids received from respective real estate developers for the same construction project. As shown, a visual side-by-side comparison can then be generated that contains a graphical representation of each of the multiple bids by the respective developers. As shown in the exemplary embodiment of FIG. 6A, for instance, a graph 664a provides a visual side-by-side comparison of the total real estate net present value, (the chosen metric 665a), for each of a plurality of proposed buildings (see, for example, bar 669a representing the “Charger II” building) associated with a bid from a respective one of the developers. Further, as shown in the exemplary embodiment of FIG. 6B, a graph 664b provides a visual comparison of the total real estate cost (the chosen metric 665b) for each of a plurality of proposed buildings (see e.g. bar 669b) associated with the bids from the respective real estate developers.

Now referring back to FIG. 3C, From step 375, at step 376 at least one parameter of the bid can be edited, using the graphical user interface controls of the transaction analysis module 562. This can be, for instance, a cost parameter (e.g. base rental rate) for at least one bid,. In the embodiment shown in FIGS. 5A-5C, the graphical user interface controls include tabs 568a and 568b for switching screen views between viewing a bid by at least one developer and the view for generating a counterbid As shown in FIGS. 5B and 5C, the graphical user interface controls also include adjustable active boxes 566 running in the Windows® operating system on the user's computer screen 559, for making dynamic adjustments to bids received by the client or broker, such that edits can be made to the details of the bid and/or such that additional, custom parameters/metrics 583 specific to the real estate client or real estate broker, but not the real estate developer, can be added in custom fields 582a and 582b, and such that at least one counterbid with the adjusted details can be provided back to the developer(s).

From step 376, at step 377 if the counterbid is complete and accurate, at step 378, then it can be provided-submitted for review by the corresponding real estate developer(s) at step 380 or saved for review at step 379. At step 381, the user is logged-off. In addition, the functions of submitting a counterbid and/or closing the transaction analysis module 562 can be accomplished by interacting with (e.g. clicking on) the buttons 588a and 588b, respectively. As shown in FIG. 5A, the data associated with the bid by each developer includes rental rates, taxes, and insurance, at reference numeral 565 projected over a period of 10 years in chart 564a.

Referring back to FIG. 3A and the step 324 of editing user account information, from this step, user contact information and/or user password is edited at step 326, and data associated with the edited user contact information or user password is stored at step 327. From the step 328 of resetting a user password, a new user password is entered at step 329, the password is reset, at step 330, and a confirmed password is received at step 331.

Referring now to FIGS. 1-5, in one aspect, the present invention relates to a site selection system 100. The system 100 includes a representation means 101a for generating visual representations 484, 564 of data to at least one user 101, an interface means 480, 560 having interactive user controls 486, 488, 566, 568 for manipulating data in response to an action by the at least one user 101, an analysis means 482, 562 for analyzing data, a communication means 130 for sending and receiving data to and from the at least one user 101, a storage means 120-128 for storing data saved by the at least one user 101, and a network server 110 in communication with and programmed for controlling the functions performed by each of the representation means 101a, interface means 480, 560, analysis means 482, 562,communication means 130, and storage means 120-128, where the data contains real estate information, and where at least one of the representation means 101a, interface means 480, 560, analysis means 482, 562, and communication means 130 is operatively associated with the at least one user 101 through a network connection 111. As shown in FIGS. 1A and 1B, the at least one user 101 is at least one of a real estate client 114, real estate developer 116, real estate broker 112, data subscriber 118, and system administrator 108. The real estate information is associated with at least one real estate construction project and includes at least one of request-for-proposal, pricing model, pricing kit, project date, bid, and counterbid.

Now referring specifically to the embodiments shown in FIGS. 4, and 5A-5C, respectively, the interactive user controls 486, 488, 566, 568 are graphical user interface controls displayed on a computer screen 481, 559. The visual representations 484, 564generated by the representation means 101a include at least one of graphs, charts, and numeric representations displayed on a computer screen 481, 559.

In one embodiment, the system further includes an access control means 108, 201, 301, for controlling access to at least one of the representation means 101a, interface means 480, 560, analysis means 482, 562,communication means 130, and storage means 120-128 based upon the identity of the user 101 as a real estate client 114, real estate developer 116, real estate broker 112, data subscriber 118, or system administrator 108. As shown in the embodiment of FIG. 1A, the network connection 111 is an internet connection and at least one of the representation means 101a, interface means 480, 560, analysis means 482, 562, and communication means 130 is operatively associated with a user computer through the network connection 111. At least one of the representation means 101a, interface means 480, 560, analysis means 482, 562, and communication means 130 is a web-based application.

In another aspect, the present invention relates to a computerized site selection system 100. In one embodiment, the system 100 includes a developer module operable for receiving, storing, and providing data in communication with at least one real estate developer 116, a client-broker module operable for receiving, storing, and providing data in communication with at least one real estate client 114 or real estate broker 112, a client-broker transaction analysis module 562 operatively associated with the client-broker module, operable for selectively providing developer-specific information to the at least one real estate client or real estate broker 112, a developer transaction analysis module 482 operatively associated with the developer module operable for selectively providing project-specific information to at least one real estate developer 116, where the data contains real estate information and each of the developer module, client-broker module, client-broker transaction analysis module 562, and developer transaction analysis module 482 is operatively associated with a corresponding at least one of the real estate developer 116, real estate client 114, and real estate broker 112 through a network connection 111.

In one embodiment, the data provided by the client-broker module includes a request-for-proposal for a real estate construction project. The data also includes a list of real estate developers 116 eligible for bidding on a real estate construction project. The data received by the client-broker module includes real estate construction project information submitted by a real estate client 114 or real estate broker 112 that is accessible or inaccessible to a real estate developer 116, as determined by the real estate client 114, real estate broker 112, or system administrator 108. The developer module is further operable for generating at least one visual representation of data associated with at least one real estate construction project for which the real estate client 114 or real estate broker 112 has designated as open for receiving bids or for which at least one bid has been placed. The data provided by the developer module includes at least one request-for-proposal for a real estate construction project that is operable to be downloaded by a real estate client 114 or real estate broker 112. The data received by the real estate developer 116 includes at least one completed request-for-proposal for a real estate construction project.

In one embodiment, each of the developer module, client-broker module, client-broker transaction analysis module 562, and developer transaction analysis module 482 are operatively associated with a graphical user interface including controls for manipulating data in the system in response to an action by the at least one real estate developer 116, real estate client 114, or real estate developer 116. The client-broker module is further operable for providing interactive access to data associated with at least one real estate construction project provided by at least one real estate developer 116 in response to a request-for-proposal. The data contains information associated with a real estate construction project and includes at least one of a pricing model, pricing kit, bid, counterbid, request-for-proposal, and the identity of at least one real estate developer 116. The client-broker transaction analysis module 562 is operable for providing a visual side-by-side comparison of data containing two or more bids provided by two or more corresponding real estate developers 116.

In yet another aspect, the present invention relates to a method of using a computerized site selection system 100. In one embodiment, the method includes the steps of accessing the site selection system 100 through the network connection 111 and providing identification designating that the user 101 is a real estate client 114 or a real estate broker 112. The method further includes performing at least one of the steps of reviewing at least one open real estate construction project and corresponding at least one bid provided by an eligible real estate developer 116, creating a new real estate construction project, providing corresponding real estate information, and selecting, from a list of eligible real estate developers 116, at least one real estate developer 116 to receive at least one bid from, selecting, from a list of eligible real estate developers 116 that have provided at least one bid on an existing real estate construction project, a real estate developer 116 and reviewing the corresponding bid, selecting at least one metric 665 for comparing at least two bids received from at least two corresponding eligible real estate developers 116 for the same real estate construction project and viewing a generated visual comparison of the bids based on the selected at least one metric 665, and selectively providing access to at least one eligible real estate developer 116 to view at least one bid provided by at least one other eligible real estate developer 116 for the same real estate construction project.

In one embodiment, the step of providing corresponding real estate information comprises the step of entering the real estate information on a web-based form, and the selected at least one metric 665 comprises information associated with at least one of square footage, cost per square foot, taxes, fees, insurance, and base rental rate. In this embodiment, the entered real estate information includes at least one of a request-for-proposal, a start date for the real estate construction project, and an end date for the real estate construction project. The method further includes the steps of editing the entered information on a web-based form and storing the edited information.

In yet another aspect, the present invention relates to a method of using a computerized site selection system 100. The method includes the steps of accessing the site selection system 100 through the network connection 111 and providing identification containing a designation that the user 101 is a real estate developer 116. The method further includes performing at least one of the steps of receiving an association as an eligible real estate developer 116 for bidding on at least one real estate construction project, viewing real estate information associated with at least one real estate construction project that is open for receiving bids, and selecting a real estate construction project from a list of real estate construction projects that are open for receiving bids and providing a bid corresponding to the selected real estate construction project. The real estate information comprises a request-for-proposal provided by a real estate client 114 or real estate broker 112. In one embodiment, the step of providing a bid includes the step of entering real estate information on a web-based form. The step of providing a bid also includes the steps of selecting a property from a dynamic list 122 of eligible real estate properties for a construction project and associating the selected property with at least one bid. The method also includes the step of storing the entered information in a storage means 120-128 operatively associated with the web-based form. The method also includes the step of editing the entered real estate information on a web-based form.

In yet another aspect, the present invention relates to a method of using a computerized site selection system 100. In one embodiment, the method includes the steps of, if the at least one user is a real estate developer 116, accessing the site selection system 100 through the network connection 111 and providing identification containing a designation that the user 101 is a real estate developer 116. The method further includes performing at least one of the steps of receiving an association as an eligible real estate developer 116 for bidding on at least one real estate construction project, viewing real estate information associated with at least one real estate construction project that is open for receiving bids, selecting a real estate construction project from a list of real estate construction projects that are open for receiving bids and providing a bid corresponding to the selected real estate construction project.

Now also referring to FIGS. 6A and 6B, in one embodiment, the method includes the steps of, if the at least one user is a real estate client 114 or real estate broker 112, accessing the site selection system 100 through the network connection 111 and providing identification containing a designation that the user 101 is a real estate client 114 or real estate broker 112. The method further includes performing at least one of the steps of reviewing at least one open real estate construction project and corresponding at least one bid provided by an eligible real estate developer 116, creating a new real estate construction project, providing corresponding real estate information, selecting, from a list of eligible real estate developers 116, at least one real estate developer 116 to receive at least one bid from, selecting, from a list of eligible real estate developers 116 that have provided at least one bid on an existing real estate construction project, a real estate developer 116 and reviewing the corresponding bid, selecting at least one metric 665 for comparing at least two bids received from at least two corresponding eligible real estate developers 116 for the same real estate construction project and viewing a generated visual comparison 664 of the bids based on the selected at least one metric 665, and selectively providing access to at least one eligible real estate developer 116 to view at least one bid provided by at least one other eligible real estate developer 116 for the same real estate construction project.

In yet another aspect, the present invention relates to a method of using a computerized site selection system 100. In one embodiment, the method includes at least one of the steps of causing the representation means 101a to generate a visual representation 484, 564 of data, causing the interactive user controls 486, 488, 566, 568 of the interface means 480, 560 to manipulate data, causing the analysis means 482, 562 to analyze data, causing the communication means 130 to send and receive data, and causing the network server 110 to communicate with at least one of the representation means 101a, interface means 480, 560, analysis means 482, 562 communication means 130, and storage means 120-128, and to control each function of the representation means 101a, interface means 480, 560, analysis means 482, 562, communication means 130, and storage means 120-128.

In yet another aspect, the present invention relates to a method of using a computerized site selection system 100, including a developer module operable for receiving, storing, and providing data in communication with at least one real estate developer 116, a client-broker module operable for receiving, storing, and providing data in communication with at least one real estate client 114 or real estate broker 112, a client-broker transaction analysis module 562 operatively associated with the client-broker module, operable for selectively providing developer-specific information to the at least one real estate client or real estate broker 112, and a developer transaction analysis module 482 operatively associated with the developer module, operable for selectively providing project-specific information to at least one real estate developer 116, where the data contains real estate information and each of the developer module, client-broker module, client-broker transaction analysis module 562, and developer transaction analysis module 482 are operatively associated with the corresponding at least one real estate developer 116, real estate client 114, and real estate broker 112 through a network connection 111. In one embodiment, the method includes at least one of the steps of causing the developer module to perform at least one of the functions of receiving data, storing data, and providing data, causing the client-broker module to perform at least one of the functions of receiving data, storing data, and providing data, causing the client-broker transaction analysis module 562 to selectively provide developer-specific information, and causing the developer transaction analysis module 482 to selectively provide project-specific information.

In yet another aspect, the present invention relates to software stored on a computer-readable medium for causing a computing system to perform functions for interacting with at least one user 101 of a site selection system 100. In one embodiment, the functions include generating visual representations 484, 564, 664 of data to the at least one user 101, manipulating data in response to an action by the at least one user 101, analyzing data, sending and receiving data to and from the at least one user 101, and storing data saved by the at least one user 101, where the data contains real estate information and at least one of the functions of generating visual representations 484, 564 manipulating data, sending and receiving data, and storing data occurs through a network connection 111.

In yet another aspect, the present invention relates to software stored on a computer-readable medium for causing a computing system to perform functions for interacting with at least one user 101 of a site selection system 100. In one embodiment, the functions include receiving, storing, and providing data in communication with at least one real estate developer 116, receiving, storing, and providing data in communication with at least one real estate client 114 or real estate broker 112, selectively providing developer-specific information to the at least one real estate client 114 or real estate broker 112, and selectively providing project-specific information to the at least one real estate developer 116, where the data contains real estate information and each of the functions of receiving data, storing data, providing data, selectively providing developer-specific information, and selectively providing project-specific information occurs through a network connection 111.

In yet another aspect, the present invention relates to a method of using software stored on a computer-readable medium for causing a computing system to perform functions for interacting with at least one user 101 of a site selection system 100. In one embodiment, the method includes the steps of accessing the site selection system 100 through a network connection 111, providing identification containing a designation that the user 101 is a real estate developer 116, receiving data, storing data, providing data, and receiving project-specific information, where the data contains real estate information and each of the steps of receiving data, storing data, providing data and receiving project-specific information occur through an internet connection 111.

In yet another aspect, the present invention relates to a method of using software stored on a computer-readable medium for causing a computing system to perform functions for interacting with at least one user 101 of a site selection system 100. In one embodiment, the method includes the steps of accessing the site selection system 100 through an internet connection 111, providing identification containing a designation that the user 101 is a real estate client 114 or real estate broker 112, receiving data, storing data, and providing data, and receiving developer-specific information, where the data contains real estate information and each of the functions of receiving data, storing data, providing data, and receiving project-specific information occurs through an internet connection 111.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A computerized site selection system, comprising:
(a) a representation means for generating visual representations of data to at least one user;
(b) an interface means having interactive user controls for manipulating data in response to an action by the at least one user;
(c) an analysis means for analyzing data;
(d) a communication means for sending and receiving data to and from the at least one user;
(e) a storage means for storing data saved by the at least one user; and
(f) a network server in communication with and programmed for controlling the functions performed by each of the representation means, interface means, analysis means, communication means, and storage means,
wherein the data contains real estate information, and wherein at least one of the representation means, interface means, analysis means, and communication means is operatively associated with the at least one user through a network connection.

2. The system of claim 1, wherein the at least one user is at least one of a real estate client, real estate developer, real estate broker, data subscriber, and system administrator.

3. The system of claim 1, wherein the real estate information is associated with at least one real estate construction project and includes at least one of request-for-proposal, pricing model, pricing kit, project date, bid, and counterbid.

4. The system of claim 1, wherein the interactive user controls are graphical user interface controls displayed on a computer screen.

5. The system of claim 1, wherein the visual representations generated by the representation means comprise at least one of graphs, charts, and numeric representations displayed on a computer screen.

6. The system of claim 1, further comprising an access control means for controlling access to at least one of the representation means, interface means, analysis means, communication means, and storage means, based upon the identity of the user as a real estate client, real estate developer, real estate broker, data subscriber, or system administrator.

7. The system of claim 1, wherein the network connection is an internet connection and at least one of the representation means, interface means, analysis means, and communication means is operatively associated with a user computer through the network connection.

8. The system of claim 1, wherein the network connection is an internet connection and at least one of the representation means, interface means, analysis means, and communication means is a web-based application.

9. A computerized site selection system, comprising:
(a) a developer module operable for receiving, storing, and providing data in communication with at least one real estate developer;
(b) a client-broker module operable for receiving, storing, and providing data in communication with at least one real estate client or real estate broker;
(c) a client-broker transaction analysis module operatively associated with the client-broker module, operable for selectively providing developer-specific information to the at least one real estate client or real estate broker;
(d) a developer transaction analysis module operatively associated with the developer module operable for selectively providing project-specific information to at least one real estate developer,
wherein the data contains real estate information and each of the developer module, client-broker module, client-broker transaction analysis module, and developer transaction analysis module is operatively associated with a corresponding at least one of the real estate developer, real estate client, and real estate broker through a network connection.

10. The system of claim 9, wherein the data provided by the client-broker module includes a request-for-proposal for a real estate construction project.

11. The system of claim 9, wherein the data provided by the client-broker module includes a list of real estate developers eligible for bidding on a real estate construction project.

12. The system of claim 9, wherein the data received by the client-broker module includes real estate construction project information submitted by a real estate client or real estate broker that is accessible or inaccessible to a real estate developer as determined by the real estate client, real estate broker, or system administrator.

13. The system of claim 9, wherein the developer module is further operable for generating at least one visual representation of data associated with at least one real estate construction project for which the real estate client or real estate broker has designated as open for receiving bids or for which at least one bid has been placed.

14. The system of claim 9, wherein the data provided by the developer module includes at least one request-for-proposal for a real estate construction project that is operable to be downloaded by a real estate client or real estate broker.

15 The system of claim 9, wherein the data received by the real estate developer includes at least one completed request-for-proposal for a real estate construction project.

16. The system of claim 9, wherein each of the developer module, client-broker module, client-broker transaction analysis module, and developer transaction analysis module are operatively associated with a graphical user interface comprising controls for manipulating data in the system in response to an action by the at least one real estate developer, real estate client, or real estate developer.

17. The system of claim 9, wherein the client-broker module is further operable for providing interactive access to data associated with at least one real estate construction project provided by at least one real estate developer in response to a request-for-proposal.

18. The system of claim 9, wherein the data contains information associated with a real estate construction project and includes at least one of a pricing model, pricing kit, bid, counterbid, request-for-proposal, and the identity of at least one real estate developer.

19. The system of claim 9, wherein the client-broker transaction analysis module is operable for providing a visual side-by-side comparison of data containing two or more bids provided by two or more corresponding real estate developers.

20. A method of using a computerized site selection system comprising the steps of:
(a) accessing the site selection system through a network connection;
(b) providing identification designating that the user is a real estate client or a real estate broker; and
(c) performing at least one of the steps of:
(i) reviewing at least one open real estate construction project and corresponding at least one bid provided by an eligible real estate developer;
(ii) creating a new real estate construction project, providing corresponding real estate information, and selecting, from a list of eligible real estate developers, at least one real estate developer to receive at least one bid from;
(iii) selecting, from a list of eligible real estate developers that have provided at least one bid on an existing real estate construction project, a real estate developer and reviewing the corresponding bid;
(iv) selecting at least one metric for comparing at least two bids received from at least two corresponding eligible real estate developers for the same real estate construction project and viewing a generated visual comparison of the bids based on the selected at least one metric; and
(vi) selectively providing access to at least one eligible real estate developer to view at least one bid provided by at least one other eligible real estate developer for the same real estate construction project.

21. The method of claim 20, wherein the step of providing corresponding real estate information includes the step of entering the real estate information on a web-based form.

22. The method of claim 20, wherein the selected at least one metric includes information associated with at least one of square footage, cost per square foot, taxes, fees, insurance, and base rental rate.

23. The method of claim 21, wherein the entered real estate information includes at least one of a request-for-proposal, a start date for the real estate construction project, and an end date for the real estate construction project.

24. The method of claim 21, further comprising the steps of editing the entered information on a web-based form and storing the edited information.

25. A method of using a computerized site selection system comprising the steps of:
(a) accessing the site selection system through a network connection;
(b) providing identification containing a designation that the user is a real estate developer; and
(c) performing at least one of the steps of:
(i) receiving an association as an eligible real estate developer for bidding on at least one real estate construction project;
(ii) viewing real estate information associated with at least one real estate construction project that is open for receiving bids; and
(iii) selecting a real estate construction project from a list of real estate construction projects that are open for receiving bids and providing a bid corresponding to the selected real estate construction project.

26. The method of claim 25, wherein the real estate information includes a request-for-proposal provided by a real estate client or real estate broker.

27. The method of claim 25, wherein the step of providing a bid includes the step of entering real estate information on a web-based form.

28. The method of claims 25, wherein the step of providing a bid includes the steps of selecting a property from a dynamic list of eligible real estate properties for a construction project and associating the selected property with at least one bid.

29. The method of claim 27, further comprising the step of storing the entered information in a storage means, operatively associated with the web-based form.

30. The method of claim 27, further comprising the step of editing the entered real estate information on a web-based form.

31. A method of using a computerized site selection system comprising the steps of:
(a) if the at least one user is a real estate developer,
(i) accessing the site selection system through a network connection; and
(ii) providing identification containing a designation that the user is a real estate developer; and
(iii) performing at least one of the steps of:
(1) receiving an association as an eligible real estate developer for bidding on at least one real estate construction project;
(2) viewing real estate information associated with at least one real estate construction project that is open for receiving bids; and
(3) selecting a real estate construction project from a list of real estate construction projects that are open for receiving bids and providing a bid corresponding to the selected real estate construction project; and
(b) if the at least one user is a real estate client or real estate broker,
(i) accessing the site selection system through a network connection;
(ii) providing identification containing a designation that the user is a real estate client or real estate broker; and
(iii) performing at least one of the steps of:
(1) reviewing at least one open real estate construction project and corresponding at least one bid provided by an eligible real estate developer;
(2) creating a new real estate construction project, providing corresponding real estate information, and selecting, from a list of eligible real estate developers, at least one real estate developer to receive at least one bid from;
(3) selecting, from a list of eligible real estate developers that have provided at least one bid on an existing real estate construction project, a real estate developer and reviewing the corresponding bid;
(4) selecting at least one metric for comparing at least two bids received from at least two corresponding eligible real estate developers for the same real estate construction project and viewing a generated visual comparison of the bids based on the selected at least one metric; and
(5) selectively providing access to at least one eligible real estate developer to view at least one bid provided by at least one other eligible real estate developer for the same real estate construction project.

32. A method of using a computerized site selection system comprising a representation means for generating visual representations of data to at least one user, an interface means having interactive user controls for manipulating data in response to an action by the at least one user, an analysis means for analyzing data, a communication means for sending and receiving data to and from the at least one user, a storage means for storing data saved by the at least one user, and a network server in communication with the representation means, interface means, analysis means, communication means, and storage means, wherein the network server is programmed for controlling the functions performed by each of the representation means, interface means, analysis means, communication means, and storage means, and wherein the data contains real estate information, and wherein at least one of the representation means, interface means, analysis means, and communication means is operatively associated with the at least one user through a network connection, wherein the method includes at least one of the steps of:
(a) causing the representation means to generate a visual representation of data;
(b) causing the interactive user controls of the interface means to manipulate data;
(c) causing the analysis means to analyze data;
(d) causing the communication means to send and receive data; and
(e) causing the network server to communicate with at least one of the representation means, interface means, analysis means, communication means, and storage means, and to control each function of the representation means, interface means, analysis means, communication means, and storage means.

33. A method of using a computerized site selection system, comprising a developer module operable for receiving, storing, and providing data in communication with at least one real estate developer, a client-broker module operable for receiving, storing, and providing data in communication with at least one real estate client or real estate broker, a client-broker transaction analysis module operatively associated with the client-broker module, operable for selectively providing developer-specific information to the at least one real estate client or real estate broker, and a developer transaction analysis module operatively associated with the developer module operable for selectively providing project-specific information to at least one real estate developer, wherein the data contains real estate information and each of the developer module, client-broker module, client-broker transaction analysis module, and developer transaction analysis module are operatively associated with the corresponding at least one real estate developer, real estate client, and real estate broker through a network connection, wherein the method includes at least one of the steps of:
(a) causing the developer module perform at least one of the functions of receiving data, storing data, and providing data;
(b) causing the client-broker module to perform at least one of the functions of receiving data, storing data, and providing data;
(c) causing the client-broker transaction analysis module to selectively provide developer-specific information; and
(d) causing the developer transaction analysis module to selectively provide project-specific information.

34. Software stored on a computer-readable medium for causing a computing system to perform functions for interacting with at least one user of a site selection system, comprising:
(a) generating visual representations of data to the at least one user;
(b) manipulating data in response to an action by the at least one user;
(c) analyzing data;
(d) sending and receiving data to and from the at least one user; and
(e) storing data saved by the at least one user,
wherein the data contains real estate information and at least one of the functions of generating visual representations, manipulating data, sending and receiving data, and storing data occurs through a network connection.

35. Software stored on a computer-readable medium for causing a computing system to perform functions for interacting with at least one user of a site selection system, comprising:
(a) receiving, storing, and providing data in communication with at least one real estate developer;
(b) receiving, storing, and providing data in communication with at least one real estate client or real estate broker; and
(c) selectively providing developer-specific information to the at least one real estate client or real estate broker; and
(d) selectively providing project-specific information to the at least one real estate developer,
wherein the data contains real estate information and each of the functions of receiving data, storing data, providing data, selectively providing developer-specific information, and selectively providing project-specific information occurs through a network connection.

36. A method of using software stored on a computer-readable medium for causing a computing system to perform functions for interacting with at least one user of a site selection system, comprising the steps of:
(a) accessing the site selection system through a network connection; and
(b) providing identification containing a designation that the user is a real estate developer;
(c) receiving data;
(d) storing data;
(e) providing data; and
(f) receiving project-specific information,
wherein the data contains real estate information and each of the functions of receiving data, storing data, providing data and receiving project-specific information occurs through an internet connection.

37. A method of using software stored on a computer-readable medium for causing a computing system to perform functions for interacting with at least one user of a site selection system, comprising the steps of:
(a) accessing the site selection system through an internet connection;
(b) providing identification containing a designation that the user is a real estate client or real estate broker;
(c) receiving data,
(d) storing data, and
(e) providing data; and
(d) receiving developer-specific information,
wherein the data contains real estate information and each of the functions of receiving data, storing data, providing data, and receiving project-specific information occurs through an internet connection.
